(19) United States
(12) Patent Application Publication
(10) Pub. No.: US 2025/0100523 A1
(43) Pub. Date: Mar. 27, 2025

(54) HYDRAULIC BRAKE SYSTEM FOR LOW TEMPERATURES AND METHOD FOR OPERATING SUCH A BRAKE SYSTEM

(71) Applicant: Continental Automotive Technologies GmbH, Hannover (DE)

(72) Inventors: Andreas Neu Neu, Kuhardt (DE); Michael Hitzel, Rödermark (DE); Christian Courth, Frankfurt (DE); Harald Biller, Eschborn (DE); Sebastian Mihm, Usingen (DE)

(73) Assignee: Continental Automotive Technologies GmbH, Hannover (DE)

(21) Appl. No.: 18/728,866

(22) PCT Filed: Jan. 9, 2023
(86) PCT No.: PCT/DE2023/200006

§ 371 Date: Jul. 13, 2024

(30) Foreign Application Priority Data
Jan. 13, 2022 (DE) 10 2022 200 332.2
Apr. 25, 2022 (DE) 10 2022 203 990.4

(51) Int. Cl. B60T 13/66; B60T 17/22

(52) U.S. Cl. CPC B60T 13/662; B60T 17/221; B60T 2270/88; B60Y 2400/81

(57) ABSTRACT

A a hydraulic brake system comprises a hydraulic pump for conveying brake fluid from a suction side to a pressure side, at least one electrically controlled hydraulic valve, and a brake fluid reservoir, which is connected to the suction side of the pump, and at least one control unit for controlling the hydraulic pump and the at least one hydraulic valve. In order to improve the availability at low temperatures, the control unit is configured, when a limit temperature is undershot and/or a limit viscosity is exceeded, to heat the brake fluid reservoir by means of the at least one electrically controlled hydraulic valve by actuating it with an electric current.

### TECHNICAL FIELD

The embodiments relate to a hydraulic brake system and at least one control unit the brake system.

### BACKGROUND

Modern redundant brake systems typically have two independent electric pressure delivery devices which are usually also actuated by different control units. This means that a minimum delay can be ensured even in the event of a failure of one of the pressure delivery devices.

Such a brake system is known from WO 2017/144201 A1, with a brake-by-wire brake system for implementing normal braking operations and an additional module as a backup brake system. A brake fluid reservoir is installed in this additional module to reliably supply it with brake fluid.

However, at extremely low temperatures the brake fluid has increased viscosity. This increased viscosity adversely affects the volumetric flow to the suction side of the pump in the components.

### SUMMARY

It is therefore an object to provide a brake system which ensures the vehicle deceleration even at low temperatures.

The object is achieved in that the control unit is configured to heat the brake fluid reservoir by means of the at least one electrically controlled hydraulic valve when a limit temperature is undershot, by actuating it with an electric current. As an alternative to the temperature, the viscosity of the brake fluid is directly considered, which is the medium that determines the pressure build-up. If this exceeds a limit viscosity, the reservoir and thus the brake fluid in it are heated. This enables a sufficiently fast pressure build-up even at low temperature.

In one embodiment, the hydraulic pump is configured as a piston pump, and a linear actuator is further provided, wherein the control unit is configured to actuate the linear actuator for pressure build-up in a fault-free case and to actuate the piston pump for pressure build-up in the event of a fault in the linear actuator. The hydraulic brake system thus has a high level of redundancy and can therefore do without the need for a driver-dependent hydraulic fallback level. This is necessary for autonomous driving or for the design of the brake system with a so-called e-Pedal.

In one embodiment, the control unit is implemented in multiple parts, wherein a first control unit actuates the linear actuator and a second control unit actuates the piston pump. The first control unit is also called the actuator ECU. Since the second control unit typically controls the wheel valves in addition to the piston pump, this is called the modulator ECU. This means that the electronics are also of redundant configuration.

The hydraulic pump may have enlarged bores on the suction side to further reduce the flow resistance. For example, the bores on the suction side can have a size of from 5 mm to 15 mm, e.g. of from 5 mm to 8 mm, or of 6.5 mm. The further bores of the brake system can at the same time be configured to be smaller than 5 mm, for example from 2 mm to 5 mm, e.g. from 3.3 to 4.46 mm.

In one embodiment, the brake fluid reservoir is installed together with the at least one electrically controlled hydraulic valve in a housing block. Thus, the generated heat is conducted satisfactorily to the reservoir. The brake fluid reservoir is configured simply as a cavity in the housing block. The piston pump is also installed in this housing block, with the result that the entire path lies within the heated housing block.

In one embodiment, the brake fluid reservoir is configured as a line connection between two hydraulic units within the housing block.

In one embodiment, a plurality of electrically op controlled hydraulic valves are installed in the housing block, wherein all valves are energized for heating and/or the valve or valves at the smallest spacing from the brake fluid reservoir is/are energized.

In one embodiment, the volume of the brake fluid reservoir is matched with a pressure-volume characteristic curve in such a way that the volume mathematically allows a delay of 2.44 m/s\hat{ }2.

In one embodiment, the limit temperature lies between −20 and −30° C., e.g. at −25° C.

In one embodiment, the control unit is configured to measure the viscosity. To this end, the linear actuator is actuated to convey a specified volumetric flow through an outlet valve. A pressure sensor is used to measure the pressure difference which is set and to determine the viscosity from these variables and the aperture equation of the outlet valve. Curves or tables which allow the viscosity to be determined can also be stored for the variables.

In one embodiment, the control unit is configured to energize the valves at the beginning of heating with a maximum current for a predetermined period of time or up to a predetermined temperature and then to energize them with a lower holding current. This quickly reaches the required temperature and at the same time prevents overheating and therefore possible damage to the valves.

In one embodiment, the control unit is configured to energize the valves for heating with a current based on the deviation of the temperature from the limit temperature and/or the viscosity from the limit viscosity. The heating output is thus adapted to the actual circumstances.

In one embodiment, the coil temperature is determined during heating. To this end, the resistance R of the coils can be estimated by evaluating, e.g. cyclically every 10 seconds, the duty cycle dc of the pulse width modulation (PWM) and the measured current I at a given voltage U (R=U*dc/I), and finally, the coil temperature is determined from the ratio of the current resistance to the known resistance at room temperature.

Alternatively, the resistance of the coils is estimated by, e.g. cyclically every 10 seconds, the parameters L and in particular R being determined from several dynamic measured values of coil current and coil voltage by means of the method of the smallest squares. Finally, the coil temperature is determined from the ratio of the current resistance to the known resistance at room temperature.

Optionally, the resistance can be measured by the given electronics.

In one embodiment, the heating is closed loop or open loop controlled. In closed loop controlled operation, a temperature sensor, which is located in particular in the pressure sensor, is evaluated accordingly. Thus, the heating is closed loop controlled by means of the measured value of the temperature to a setpoint value of the temperature.

In open loop controlled operation, a predetermined necessary heating output can be set at a known ambient temperature. This can be carried out for example divided into phases “heating up” and “maintaining temperature”, in which the heating output is selected accordingly.

The object is achieved, moreover, by a method for controlling a hydraulic brake system comprising a hydraulic pump for conveying brake fluid from a suction side to a pressure side, at least one electrically controlled hydraulic valve, and a brake fluid reservoir, which is connected to the suction side of the pump, wherein, when a limit temperature is undershot, the reservoir is heated by means of the at least one electrically controlled hydraulic valve, which is actuated by an electric current.

### BRIEF DESCRIPTION OF THE DRAWINGS

The present embodiments will become more fully understood from the detailed description and the accompanying drawings, wherein:

FIG. 1 shows a first embodiment of a brake system,

FIG. 2 shows an alternative embodiment of a brake system,

FIG. 3 schematically shows the method of controlling the brake system,

FIG. 4 shows exemplary variables during the execution of the method.

### DETAILED DESCRIPTION

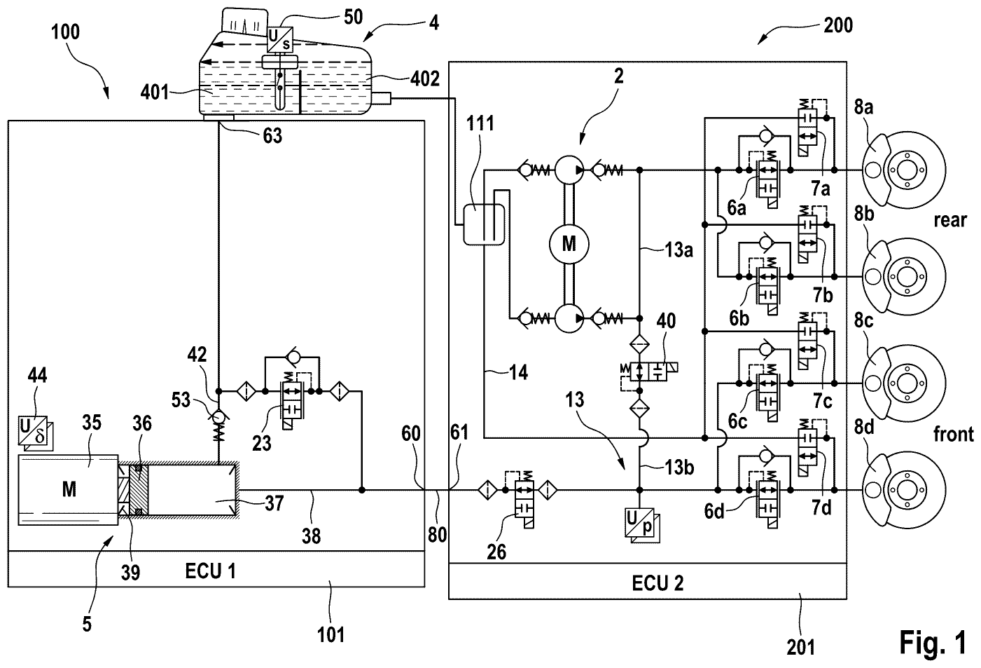

FIG. 1 highly schematically illustrates a first exemplary embodiment of a brake system for a motor vehicle. According to the example, the brake system is configured for actuating four hydraulically actuable wheel brakes 8a-8d; an extension to more wheel brakes is easily possible. According to the example, the wheel brakes 8a, 8b are assigned to the rear axle (rear) and the wheel brakes 8c, 8d are assigned to the front axle (front) of the vehicle.

The brake system comprises a first structural unit 100, which is configured, according to the example, as a first electrohydraulic brake control unit (HECU1) with a valve block HCU1 and a first electronic control device 101 (ECU1), and a second structural unit 200, which is configured, for example, as a second electrohydraulic brake control unit (HECU2) with a valve block HCU2 and a second electronic control device 201 (ECU2).

A pressure medium reservoir 4 with two chambers is arranged on the first structural unit 100, wherein the first chamber 401 is assigned a first container connection, and the second chamber 402 is assigned a second container connection.

A first electrically actuable pressure source 5 is arranged in the first structural unit 100.

A second electrically actuable pressure source 2 and wheel-specific brake pressure modulation valves are arranged in the second structural unit 200, which are designed as an electrically actuable inlet valve 6a-6d and an electrically actuable outlet valve 7a-7d per wheel brake 8a-8d.

The first pressure source 5 and the second pressure source 2 are connected on the pressure side to a brake supply line 13, to which the four inlet valves 6a-6d are connected. All four wheel brakes 8a-8d can thus be actuated by means of the first pressure source 5 or by means of the second pressure source 2.

Arranged in the brake supply line 13 is an electrically actuable circuit isolation valve 40, with the result that, when the circuit isolation valve 40 is closed, the brake supply line 13 is divided into a first line section 13a, to which the inlet valves 6a, 6b and the wheel brakes 8a, 8b are connected, and a second line section 13b, to which the inlet valves 6c, 6d and the wheel brakes 8c, 8d are connected. The second pressure source 2 is hydraulically connected to the first line section 13a, and the first pressure source 5 is hydraulically connected to the second line section 13b. When the circuit isolation valve 40 is closed, the brake system is thus split or divided into two hydraulic brake circuits I and II. In the first brake circuit I, the pressure source 2 is connected (via the first line section 13a) to only the wheel brakes 8a and 8b, and in the second brake circuit II, the first pressure source 5 is connected (via the second line section 13b) to only the wheel brakes 8c and 8d. The circuit isolation valve 40 is configured to be normally open.

The brake system comprises, as already mentioned, for each hydraulically actuable wheel brake 8a-8d an inlet valve 6a-6d and an outlet valve 7a-7d, which are hydraulically interconnected in pairs via center connectors and are each connected to a hydraulic wheel connector of the second structural unit 200, to which the corresponding wheel brake 8a-8d is connected. A check valve opening toward the brake supply line 13 is connected in parallel to each of the inlet valves 6a-6d. The outlet connectors of the outlet valves 7a-7d are connected via a common return line 14 to a reservoir 111 and via this to the pressure medium reservoir 4 or its chamber 402. The input connectors of all inlet valves 6a-6d can be supplied by means of the brake supply line 13 (that is to say when the circuit isolation valve 40 is open) with a pressure which is provided by the first pressure source 5 or, for example in the event of a failure of the first pressure source 5, by the second pressure source 2.

The first electrically controllable pressure source 5 of the valve block HCU1 is configured as a hydraulic cylinder-piston arrangement (or a single-circuit electro-hydraulic actuator (linear actuator)), the piston 36 of which can be actuated by a schematically indicated electric motor 35 with the intermediate connection of a likewise schematically illustrated rotational/translational gear mechanism 39, in particular can be moved forward and backward, to build up and release a pressure in a pressure chamber 37. The piston 36 delimits the pressure chamber 37 of the pressure source 5. For the actuation of the electric motor, a rotor position sensor 44 is provided, which detects the rotor position of the electric motor 35 and which is merely schematically indicated.

A system pressure line section 38 is connected to the pressure chamber 37 of the first electrically controllable pressure source 5. By means of the line section 38, the pressure source 5 or the pressure chamber 37 is connected to a hydraulic connector 60 of the first structural unit 100, which is connected via a hydraulic connecting element 80 to a hydraulic connector 61 of the second structural unit 200. The connection 80 is the only hydraulic pressure connection, between the first and the second structural unit. It is a hydraulic connection for transmitting a brake pressure to actuate the wheel brakes 8a-8d. The connecting element 80 therefore has to be of pressure-resistant configuration.

The pressure chamber 37 is connected to the pressure medium reservoir 4 or its chamber 401 via a (replenishing) line 42 by way of a hydraulic connection 63 of the first structural unit 100, regardless of the operating state of the piston 36. A check valve 53 which closes in the direction of the pressure medium reservoir 4 is arranged in the line 42. The cylinder-piston arrangement 5, according to the example, has no snifter holes.

Furthermore, the pressure chamber 37 is connected, according to the example, via the line section 38 and an electrically actuable, normally open, second isolation valve 23 to the line 42 or the hydraulic connection 63. A check valve opening in the direction of the pressure chamber 37 is connected in parallel to the second isolation valve 23.

In addition to the (replenishing) connection 63 and the (pressure) connector 60, the first structural unit 100 does not comprise any further hydraulic connectors.

The second electrically open loop controllable pressure source 2 of the second structural unit 200 is designed, according to the example, as a two-piston pump, the two pressure sides of which are interconnected. The suction sides are connected via the reservoir 111 to the return line 14 and thus to the pressure medium reservoir 4. The pressure sides are connected to the first line section 13a of the brake supply line 13.

In addition to the pressure source 2 and the brake pressure modulating valves 6a-6d, 7a-7d, an electrically actuable, normally open, isolation valve or switch-on valve 26 is arranged in the second structural unit 200, according to the example. The isolation valve 26 is hydraulically arranged between the connector 61 and the second line section 13b of the brake supply line 13. Thus, the first pressure source 5 is connected to the second line section 13b or the brake supply line 13 via the isolation valve 26 such that it can be disconnected.

The brake system comprises, according to the example, a pressure sensor 19, which is thus assigned to the first pressure source 5, in the brake circuit II (line section 13b). This is for rupture protection in the case of active circuit isolation, that is to say when the circuit isolation valve 40 is closed. However, the pressure sensor 19 can also be arranged in the brake circuit I or a second pressure sensor can be provided, with the result that each of the two brake circuits I and II can be directly monitored by means of a pressure sensor.

According to the example, for leakage monitoring, the brake system comprises a level measuring device 50 for determining a pressure medium level in the pressure medium reservoir 4.

According to the example, the components 5, 53, 23 and the line sections 38, 42 are arranged in the first valve block HCU1, and the components 2, 6a-6d, 7a-7d, 26, 19 and the line sections 13a, 13b (and the line sections between the inlet and outlet valves on the one side and the wheel connections on the other side) in the second valve block HCU2.

An electronic control device 101, 201 is assigned (ECU1, ECU2) to each valve block HCU1, HCU2. Each electronic control device 101, 201 comprises electrical and/or electronic elements (e.g. microcontrollers, power modules, valve drivers, other electronic components, etc.) for actuating the electrically actuable components of the associated valve block and, if necessary, the associated sensors. The valve block and the electronic control device are configured in a known manner as an electrohydraulic unit (HECU).

The first electronic open loop control device 101 actuates the first pressure source 5. According to the example, the first pressure source 5 is supplied with energy (from a first electrical power source) via the first electronic open loop control device 101.

The second electronic open loop control device 201 actuates the second pressure source 2. According to the example, the second pressure source 2 is supplied with energy (from a second electrical power source) via the second electronic open loop control device 201.

According to the example, the first pressure source 5 can be or is actuated exclusively by way of the first electronic open loop control device 101, and the second pressure source 2 can be or is actuated exclusively by way of the second electronic open loop control device 201.

The brake system has a primary pressure source 5 and a secondary pressure source 2, each electrically operated by an ECU, with a suction connector and a pressure connector. No brake fluid can flow into the pressure connector of the secondary pressure source 2 even when the system is de-energized. The primary pressure source 5 is preferably a linear actuator with a replenishing check valve 53, and the secondary pressure source 2 is a piston pump. The secondary pressure source 2 can preferably generate a higher pressure than the primary pressure source 5.

The suction sides of the two pressure sources 2, 5 are connected to a pressure medium reservoir 4, for example each to one of two separate chambers (402, 401).

The pressure side of the primary pressure source 5 is connected to a primary circuit node (second line section 13b) via an electromagnetic valve 26 (also called a pressure switch-on valve).

The pressure side of the secondary pressure source 2 is directly connected (without an intermediate connection of a valve) to a secondary circuit node (first line section 13a). The two circuit nodes (line sections 13a, 13b) are connected to each other via an electromagnetic valve 40 (also called a circuit dividing valve).

In normal operation, the pressure in the wheel brakes is built up by the primary pressure source 5 with the isolation valve 23 closed. The pressure is dissipated to the primary pressure source 5 or via the isolation valve 23. The pressure is modulated by the inlet and outlet valves on a wheel-by-wheel basis if required. If necessary, the isolation valve 26 is closed so that the primary pressure source 5 can replenish additional volume.

When a high volumetric flow is requested, both pressure sources 5 and 2 operate simultaneously in parallel. In this case, the pressure dissipation occurs at least partially via the isolation valve 23, which may be configured as an analog valve, i.e. can control its throughflow. When a high pressure is requested, the isolation valve 26 is closed and the secondary pressure source 2 increases the pressure beyond the pressure of the primary pressure source 5. Outside of braking operations, the atmospheric pressure equalization is permanently ensured via the isolation valve 23 and the isolation valve 26.

In the event of a leak in the brake system, the circuit isolation valve 40 is closed, dividing the system into two independent brake circuits I and II.

The isolation valve 23 may be actuated by the primary ECU 101. The isolation valve 26 may be actuated by the secondary ECU 201. The following description of operation in the event of a fault refers to this valve assignment.

If the primary system fails electrically, for example, the primary ECU 101 or its power supply, the secondary ECU 201 closes the isolation valve 26 to build up pressure via the secondary pressure source 2. Pressure is dissipated via the isolation valve 26 or via the outlet valves 7a-7d. Preferably, the inlet and outlet valves are actuated by the secondary ECU 201, with the result that the pressure can be modulated on a wheel-by-wheel basis.

If the secondary system fails electrically, for example the secondary ECU 201 or its voltage source, the pressure is built up and dissipated as in normal operation via the primary pressure source 5 and, if necessary, the isolation valve 23. Closed loop pressure control on a wheel-by-wheel basis has to be dispensed with, but joint modulation of the wheel pressures remains possible, in order to prevent the vehicle being destabilized by way of locking wheels.

In the event of a failure of the ECU 1 and thus of the linear actuator 5, the piston pump 2 in the ECU 2 should also be able to displace so much volume within 500 ms in low temperature ranges of up to −40° C. that a delay of 2.44 m/s² can be achieved. For typical brake characteristics, a volumetric flow of approximately 5 cm³/s may be set.

The the exponentially increasing viscosity of the brake fluid affects the volumetric flow to the suction side of the pump in the components:
The line between the reservoir and the hydraulics of the ECU2
The drilled lines in the hydraulics of the ECU2
On the suction valves of the pump of the ECU2

It has been shown that the greatest effect is at the suction valves of the pump. Therefore, it is an object of the embodiments to supply the pump with a sufficiently high preheated volume of brake fluid on the suction side. One solution may consist of a combination of different features. These are on the one hand optimized enlarged bores on the suction side of the pump within the hydraulics of ECU2 and an additional reservoir (Res) on the suction side of the pump. In addition, the hydraulics of the ECU2 are heated to at least −25° C.

The reservoir typically has the volume required to achieve a deceleration of at least 2.44 m/s³. At −25° C., the pump can set the required volumetric flow.

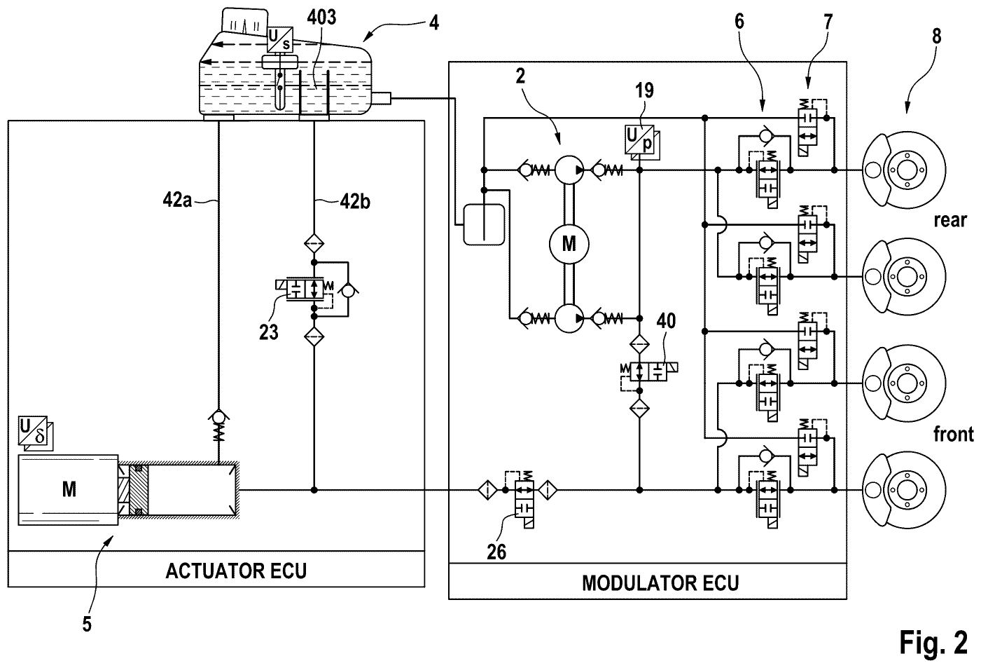

FIG. 2 shows one alternative embodiment of the brake system of FIG. 1. This corresponds to the brake system of FIG. 1 except for the changes described below. Firstly, the isolation valve 23 is connected by way of its own line 42b to the brake fluid reservoir 4, which is configured separately from the replenishing line 42a of the linear actuator 5. The brake fluid reservoir has its own subchamber 403 for this purpose. Moreover, the pressure sensor 19 is arranged above the circuit isolation valve 40 and thus on the side of the piston pump 2.

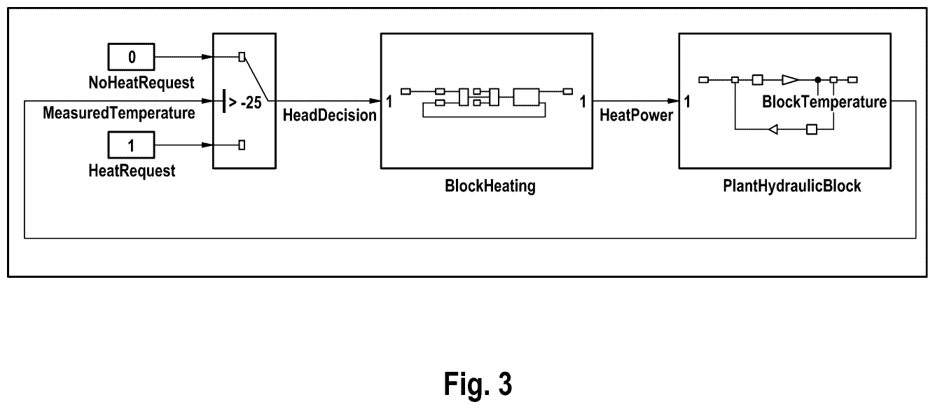

FIG. 3 shows the closed loop control implemented in the control device 201. If the measured temperature is less than −25° C., heating is carried out. This is shown schematically in the “Block Heating” field. This heating has an influence on the temperatures in the entire system, which is shown in the “PlantHydraulicBlock” field. The temperature which is set is returned as a closed loop control variable.

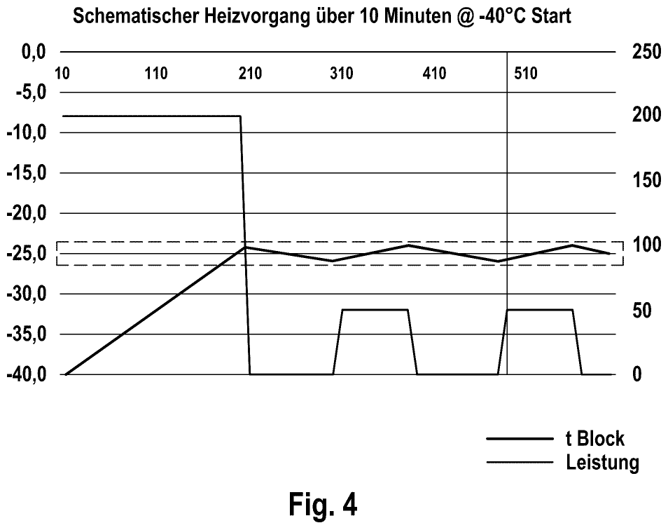

FIG. 4 now shows one embodiment, which begins at a temperature of the housing block of the brake system of −40° C. Since the temperature lies below the limit of −25° C., heating is activated. All coils are energized with a maximum current, that is, until they have an average winding temperature of 120° C., which is checked by means of a resistance measurement. This corresponds to a heating output of 200 W. As a result, the reservoir heats up at about 5K/min. When the upper setpoint value is reached, the heating is deactivated until a lower limit value is again reached. The heating is then activated again with a reduced power of approximately 50 W. This keeps the temperature within the limits shown.

Instead of the observation of the temperature, the viscosity can also be directly observed, which directly measures the relevant target variable. Errors of the inaccurate temperature sensor therefore do not play a role, whereby the heating is actually activated only when this is absolutely necessary. To measure the viscosity, the linear actuator is actuated to convey a predetermined volumetric flow through an outlet valve of a rear wheel. A pressure sensor is used to measure the pressure difference which is set and to determine the viscosity from these variables and the aperture equation of the outlet valve. The temperature delta to be applied is determined from the ratio of measured and desired viscosity from the typical relationship of the viscosity being halved per 6 Kelvin temperature increase (regardless of type and water content). For example, it follows from Vₘₑₛₛ/Vₛₒₗₗ=8=23 that ΔT=3*6K=18 Kelvin.

From this value, a corresponding heating output is determined and provided: P=α*Δϑ where α is a thermal conductance value, which is determined by design and experiments and is stored in the control unit.

The heating output is the sum of the individual outputs for all the valves involved. During heating, the temperature can be monitored for when the temperature delta calculated from the viscosity is reached. Since only temperature changes are considered, the larger statistical errors (offset) of the temperature sensor are eliminated, which improves accuracy. If necessary, the heating output P can be adjusted if, for example, the external temperature changes.

Then, if necessary, the viscosity measurement can be repeated to check whether the heating has been successful.

By heating the reservoir directly on the suction side of the hydraulic pump, acceptable pressure dynamics and thus the availability of the fallback plane at low temperature can be ensured even in the event of partial failure of the linear actuator. The method can be implemented without additional hardware.

1. A hydraulic brake system comprising:
a hydraulic pump for conveying brake fluid from a suction side to a pressure side,
at least one electrically controlled hydraulic valve,
a brake fluid reservoir, which is connected to the suction side of the pump, and
at least one control unit for controlling the hydraulic pump and the at least one hydraulic valve, wherein the control unit is configured to heat the brake fluid reservoir by actuating the at least one electrically controlled hydraulic valve with an electric current when at least one of a limit temperature of the brake fluid is undershot and a limit viscosity of the brake fluid is exceeded.

2. The hydraulic brake system as claimed in claim 1, wherein the hydraulic pump is a piston pump, and a linear actuator is further provided, wherein the control unit is configured to actuate the linear actuator for pressure build-up in a fault-free case and to actuate the piston pump for pressure build-up in the event of a fault in the linear actuator.

3. The hydraulic brake system as claimed in claim 2, wherein the control unit is implemented in multiple parts, wherein a first control unit actuates the linear actuator and a second control unit actuates the piston pump.

4. The hydraulic brake system as claimed in claim 1, wherein the brake fluid reservoir is installed with the at least one electrically controlled hydraulic valve in a housing block.

5. The hydraulic brake system as claimed in claim 1, wherein the brake fluid reservoir is a line connection between two hydraulic units within the housing block.

6. The hydraulic brake system as claimed in claim 4, wherein, the at least one hydraulic valve is a plurality of hydraulic valves installed in the housing block, wherein at least one of energizing all of the plurality of valves and energizing at least one valve of the plurality of valves, which is at the smallest spacing from the brake fluid reservoir.

7. The hydraulic brake system as claimed in claim 1, wherein a volume of the brake fluid reservoir is matched with a pressure-volume characteristic curve of the brakes such that the volume mathematically allows a delay of 2.44 m/s\hat{ }2.

8. The hydraulic brake system as claimed in claim 1, wherein the limit temperature lies between −20 and −30° C.

9. The hydraulic brake system as claimed in claim 1, wherein the control unit is configured to measure the viscosity by a predetermined volumetric flow being conveyed through an outlet valve and the pressure difference which is set being measured.

10. The hydraulic brake system as claimed in claim 1, wherein the control unit is configured to energize the at least one valve at the beginning of heating with a maximum current for one of a predetermined period of time and up to a predetermined temperature and then to energize them with a lower holding current.

11. The hydraulic brake system as claimed in claim 1, wherein the control unit is configured to energize the at least one valve for heating with a current based on at least one of a deviation of brake fluid temperature from the limit temperature and a deviation of brake fluid viscosity from the limit viscosity.

12. The hydraulic brake system as claimed in claim 1, wherein a coil temperature is determined during heating.

13. The hydraulic brake system as claimed in claim 1, wherein the heating is one of closed loop controlled and open loop controlled.

14. A method for controlling a hydraulic brake system comprising:
controlling a hydraulic pump and at least one hydraulic valve with a control unit;
conveying brake fluid from a suction side to a pressure side with the hydraulic pump; and
actuating the at least one hydraulic valve with an electric current to heat the brake fluid when at least one of a limit temperature of the brake fluid is undershot and a limit viscosity of the brake fluid is exceeded.

15. The method of claim 14, wherein the controlling by the control unit is one of an open loop control and a closed loop control.

16. The method of claim 14, wherein the at least one hydraulic valve is a plurality of electrically open loop controlled hydraulic valves installed in the housing block, and further comprising at least one of energizing all of the plurality of valves and energizing at least one valve of the plurality of valves which is at the smallest spacing from the brake fluid reservoir.

17. The method of claim 14, further comprising conveying a predetermined volumetric flow through an outlet valve and measuring a pressure difference to measure the viscosity

18. The method of claim 14, further comprising energizing the at least one valve with a maximum current at the beginning for one of a time period and up to a predetermined temperature then energizing the at least one valve with a holding current which is less than the maximum current.

19. The method of claim 14, wherein energizing the at least one valve with a current is based on at least one of a deviation of the brake fluid temperature from the limit temperature and a deviation of the brake fluid viscosity from the limit viscosity.
